(19) United States
(12) Patent Application Publication
(10) Pub. No.: US 2005/0141393 A1
(43) Pub. Date: Jun. 30, 2005

(54) Objective lens, optical pickup apparatus and optical information recording and reproducing apparatus

(75) Inventor: Katsuya Sakamoto, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/017,050

(22) Filed: Dec. 21, 2004

(30) Foreign Application Priority Data
Dec. 25, 2003 (JP) JP2003-430250

(51) Int. Cl. G11B 7/00

(52) U.S. Cl. 369/112.23; 369/112.08

(57) ABSTRACT

An optical pickup apparatus for recording and/or reproducing information on a first optical information recording medium and a second optical information recording medium includes: a first light source emitting a first light flux with a wavelength λ1; a second light source emitting a second light flux with a wavelength λ2; and an objective lens of a finite conjugate type converging the first and second light fluxes. The objective lens has astigmatism for the first light flux, and the direction of occurrence for the astigmatism is the same as the direction in which astigmatism of the first light flux resulting from tracking is reduced. Further, an image height of the objective lens in the direction of tracking is within a prescribed range and astigmatism of the objective lens takes the minimum value.

### FIELD OF THE INVENTION

The present invention relates to an objective lens, an optical pickup apparatus and an optical information recording and reproducing apparatus.

### BACKGROUND OF THE INVENTION

There is sometimes used an objective lens of a finite conjugate type as an optical system for an optical pickup apparatus that conducts recording and/or reproducing of, information for optical disks such as DVD (digital versatile disc) and CD (compact disc). By making an objective lens to be of a finite conjugate type, an optical element such as a collimator that causes a parallel light to enter an objective lens turns out to be unnecessary, which makes it possible to achieve a cut of the number of parts of the optical pickup apparatus and cost reduction.

However, in the case of using the objective lens of a finite conjugative type is used, when it is moved in the direction perpendicular to the optical axis for the tracking, there is caused astigmatism resulting from the use of off-axis light. So, there is known a technology wherein the aforementioned astigmatism is canceled out by astigmatism that is owned by the objective lens itself (for example, see Patent Document 1).

Further, when a semiconductor laser itself used as a light source has an astigmatic difference, there is generated astigmatism wherein the astigmatism resulting from the tracking and astigmatism caused by astigmatism owned by the semiconductor itself are combined. So, there is known a technology wherein these two astigmatisms are canceled by astigmatism owned by the objective lens (for example, see Patent Document 2).

In recent years, there has been advanced development of an optical pickup apparatus that has compatibility for plural optical disks, for example, for DVD and CD, and can conduct properly recording/reproducing of information for each optical disk.

To achieve simplification of the structure and cost reduction concerning the optical pickup apparatus having compatibility, it is effective to employ a method to standardize optical parts of each optical disk and thereby to reduce the number of optical parts which constitute an optical pickup apparatus. So, there has been developed a light source wherein two laser light sources each having a different oscillation wavelength are packed in a chip for respective optical disks. Incidentally, in the present specification, a laser light source wherein plural light-emitting points each having a different oscillation wavelength are packed in a casing is called “a packaged multiple light source unit”.

In Patent Document 3, for example, there is disclosed an optical pickup apparatus employing a packaged multiple light source unit composed of two light sources which respectively emit two types of laser light fluxes having respectively wavelength 660 nm and wavelength 785 nm, and employing an objective lens of a finite conjugate type.
(Patent Document 1) Patent No. 3104780
(Patent Document 2) Patent No. 3191200
(Patent Document 3) TOKKAI No. 2001-76367

However, neither the Patent Document 1 nor the Patent Document 2 discloses a technology with which an optical pickup apparatus has compatibility, and a technology to correct astigmatism caused in the course of tracking is not disclosed in the Patent Document 3.

### SUMMARY OF THE INVENTION

Under the consideration of the problems mentioned above, an object of the invention is to provide an objective lens of a finite conjugate type which has compatibility for plural optical disks and can correct astigmatism caused by tracking and astigmatism owned by a light source itself, an optical pickup apparatus equipped with the aforementioned objective lens and an optical information recording and reproducing apparatus.

To solve the problems stated above, the optical pickup apparatus of the invention has therein an objective lens of a finite conjugative type that converges respectively a light flux with wavelength λ1 and a light flux with wavelength λ2. The objective lens has astigmatism for the light flux with wavelength λ1, and the direction of occurrence for the astigmatism is the same as the direction in which astigmatism of the light flux with wavelength λ1 resulting from tracking is canceled. Further, an image height of the objective lens in the direction of tracking is within a prescribed range and astigmatism of the objective lens takes the minimum value.

### BRIEF DESCRIPTION OF THE DRAWINGS

FIG. 1 a plan view of primary portions showing the structure of an optical pickup apparatus.

FIG. 2 is a diagram for illustrating an astigmatic difference and astigmatism.

FIG. 3 is a graph showing image height characteristics of DVD in the first example.

FIG. 4 is a graph showing image height characteristics of DVD in the first example.

FIG. 5 is a graph showing image height characteristics of conventional DVD.

FIG. 6 is a graph showing image height characteristics of conventional CD.

FIG. 7 is a graph showing image height characteristics of DVD in the second example.

FIG. 8 is a graph showing image height characteristics of DVD in the second example.

FIG. 9 is a graph showing image height characteristics of DVD in the third example.

FIG. 10 is a graph showing image height characteristics of CD in the third example.

### DETAILED DESCRIPTION OF THE INVENTION

Preferred embodiments of the invention will be explained as follows.

Item 1

The structure described in Item 1 is an optical pickup apparatus for recording and/or reproducing information on a first optical information recording medium whose information recording surface has a first protective substrate with a thickness t1 and a second optical information recording medium whose information recording surface has a second protective substrate with a thickness t2 (t1<t2), the optical pickup apparatus comprising: a first light source emitting a first light flux with a wavelength λ1; a second light source emitting a second light flux with a wavelength λ2. (λ1<λ2); and an objective lens having a first optical surface and a second optical surface arranged on an opposite side to the first optical surface of the objective lens, converging the first light flux entering into the objective lens as a divergent light flux on the information recording surface of the first optical information recording medium through the first protective substrate and converging the second light flux entering into the objective lens as a divergent light flux on the information recording surface of the second optical information recording medium through the second protective substrate, wherein the first optical surface of the objective lens comprises a spherical aberration correcting structure for correcting a spherical aberration caused by a thickness difference between the first protective substrate and the second protective substrate, the objective lens has an astigmatism for the first light flux, and the objective lens is arranged in the optical pickup apparatus such that the astigmatism of the objective lens for the first light flux reduces an astigmatism for the first light flux caused by a tracking operation of the objective lens and is arranged in the optical pickup apparatus such that the astigmatism of the objective lens has a minimum value when an image height of the objective lens along a tracking direction is in a range of 0.30Y-0.95Y, where Y is an image height of the objective lens when a tracking operation amount has a maximum value.

Item 2

The structure described in Item 2 is the optical pickup apparatus according to Item 1, wherein the image pickup apparatus satisfies 0.05 mm≦d≦0.15 mm, where d is a distance between emitting points of the first light source and the second light source, and the first light source and the second light source are arranged in the optical pickup apparatus such that a distance along an optical axis from the emitting point of the first light source to a surface of the first optical information recording medium facing the objective lens is same as a distance along the optical axis from the emitting point of the second light source to a surface of the second optical information recording medium facing the objective lens.

Incidentally, in the present specification, optical disks in DVD series such as DVD-ROM, DVD-Video, DVD-Audio, DVD-RAM, DVD-R, DVD-RW, DVD+R and DVD+RW are called “DVD” generically, and optical disks in CD series such as CD-ROM, CD-Audio, CD-Video, CD-R and D-RW are called “CD” generically.

Further, in the present specification, “be arranged such that a distance A is same as a distance B” means that a difference between the distance A and the distance B is smaller than 0.1 mm.

In the structure described in Item 1, when Y represents an image height of the objective lens in the case of the maximum amount of tracking, lens design is carried out so that the astigmatism owned by the objective lens may take the minimum value when an image height of the objective lens in the direction of tracking is in the range from 0.30Y to 0.95Y. Owing to this, astigmatism of a light flux with wavelength λ1 caused by tracking can be reduced by astigmatism which the objective lens itself has for the light flux with wavelength λ1, thus, it is possible to obtain an optical pickup apparatus of a finite conjugate type which has compatibility for plural types of optical disks and can correct astigmatism caused by tracking.

In the structure described in Item 2, a packaged light source unit including the first light source and the second light source can be used. Owing to this, it is possible to achieve a cut of the number of parts of the optical pickup apparatus and cost reduction.

Item 3

The structure described in Item 3 is the optical pickup apparatus according to Item 1 or Item 2, wherein the first optical surface of the objective lens comprises an astigmatism providing structure for providing an astigmatism for the first light flux to the objective lens.

Item 4

The structure described in Item 4 is the optical pickup apparatus according to Item 3, wherein the astigmatism providing structure is formed by a shape of a basic asphecric surface of the objective lens.

Item 5

The structure described in Item 5 is the optical pickup apparatus according to Item 4, wherein the spherical aberration correcting structure is a diffractive structure.

Item 6

The structure described in Item 6 is the optical pickup apparatus according to Item 5, wherein the diffractive structure comprises diffractive ring-shaped zones and has a serrated sectional form.

In the structure described in Items 4-6, the astigmatism providing structure for providing an astigmatism for the first light flux to the objective lens, is arranged on the first optical surface of the objective lens and is formed by a shape of the basic aspheric form of the objective lens. Owing to this, processing of a molding die and molding the objective lens can be performed easily.

Item 7

The structure described in Item 7 is the optical pickup apparatus according to Item 3, wherein the astigmatism providing structure further provides an astigmatism for the second light flux to the objective lens, and the objective lens is arranged in the optical pickup apparatus such that the astigmatism of the objective lens for the second light flux reduces an astigmatism for the second light flux caused by a tracking operation of the objective lens and is arranged in the optical pickup apparatus such that the astigmatism for the second light flux of the objective lens has a minimum value when the image height of the objective lens along a tracking direction is in a range of 0.30Y-0.95Y.

Item 8

The structure described in Item 8 is the optical pickup apparatus according to Item 7, wherein the astigmatism providing structure is arranged such that the astigmatism providing structure provides predefined astigmatism amounts for the first light flux and the second light flux respectively to the objective lens.

Item 9

The structure described in Item 9 is the optical pickup apparatus according to Item 8, wherein the astigmatism providing structure is a diffractive structure.

Item 10

The structure described in Item 10 is the optical pickup apparatus according to Item 9, wherein the diffractive structure comprises diffractive ring-shaped zones and has a serrated sectional form.

Item 11

The structure described in Item 11 is the optical pickup apparatus according to Item 10, the diffractive ring-shaped zones have elliptic shapes.

In the structures of Items 9-11, it is possible to provide a wavelength-selectivity for the astigmatism providing structure and provide predefined astigmatism amounts for the first light flux and the second light flux respectively. Owing to this, astigmatism relating to the light flux with wavelength λ2 can be corrected effectively, and aberration correcting functions of the optical pickup apparatus can be improved.

Item 12

The structure described in Item 12 is the optical pickup apparatus according to Item 1, wherein the second optical surface of the objective lens comprises an astigmatism providing structure for the first light flux to the objective lens.

Item 13

The structure described in Item 13 is the optical pickup apparatus according to Item 12, wherein the astigmatism providing structure is formed by a shape of a basic asphecric surface of the objective lens.

In the structure described in Item 13, the spherical aberration correcting structure and the astigmatism providing structure are arranged on opposite sides of the objective lens and the astigmatism providing structure is formed by a shape of the basic aspheric form of the objective lens. Owing to this, processing of a molding die and molding the objective lens can be performed easily in particular.

Item 14

The structure described in Item 14 is the optical pickup apparatus according to Item 12, wherein the astigmatism providing structure further provides an astigmatism for the second light flux and the objective lens is arranged in the optical pickup apparatus such that the astigmatism of the objective lens for the second light flux reduces an astigmatism for the second light flux caused by a tracking operation of the objective lens and is arranged in the optical pickup apparatus such that the astigmatism for the second light flux of the objective lens has a minimum value when the image height of the objective lens along a tracking direction is in a range of 0.30Y-0.95Y.

Item 15

The structure described in Item 15 is the optical pickup apparatus according to Item 14, wherein the astigmatism providing structure is arranged such that the astigmatism providing structure provides predefined astigmatism amounts for a light flux with the first light flux and the second light flux respectively to the objective lens.

In the structures described in Items 14 and 15, it is possible to provide a wavelength-selectivity for the astigmatism providing structure and provide predefined astigmatism amounts for the first light flux and the second light flux respectively. Owing to this, astigmatism relating to the light flux with wavelength λ2 can be corrected effectively, and aberration correcting functions of the optical pickup apparatus can be improved. Furthermore, the spherical aberration correcting structure and the astigmatism providing structure is arranged on opposite sides of the objective lens. Owing to this, processing of a molding die and molding the objective lens can be performed easily.

Item 16

The structure described in Item 16 is the optical pickup apparatus according to Item 15, wherein the astigmatism providing structure is a diffractive structure.

Item 17

The structure described in Item 17 is the optical pickup apparatus according to Item 16, wherein the diffractive structure is a straight-line shaped diffractive structure.

Item 18

The structure described in Item 18 is the optical pickup apparatus according to any one of Items 1-17, wherein the spherical aberration correcting structure is a diffractive structure.

Item 19

The structure described in Item 19 is the optical pickup apparatus according to any one of Items 1-18, wherein the diffractive structure comprises diffractive ring-shaped zones and has a serrated sectional form.

Item 20

The invention described in Item 20 is the optical pickup apparatus according to any one of Item 1-19, wherein the objective lens is arranged in the optical pickup apparatus such that the astigmatism of the objective lens has a direction to reduce astigmatism caused by the first light flux because of a tracking operation and an astigmatism caused by an astigmatism difference of the first light source.

In the structure described in Item 20, not only astigmatism of the light flux with wavelength λ1 caused by tracking but also astigmatism caused by astigmatic difference owned by the first light source can be reduced by astigmatism owned by the objective lens itself for the light flux with wavelength λ1, which makes it possible to improve aberration correcting efficiency of the optical pickup apparatus.

Item 21

The structure described in Item 21 is an objective lens for use in an optical pickup apparatus reproducing and/or recording information on a first optical information recording medium having a protective substrate with a thickness t1 by a first light flux with a wavelength λ1 emitted from a first light source and reproducing and/or recording information on a second optical information recording medium having a protective substrate with a thickness t2 (t1<t2) by a second light flux with a wavelength λ2 emitted from a second light source, the objective lens comprising: a first optical surface and a second optical surface arranged on an opposite side to the first optical surface of the objective lens, wherein the optical objective lens converges the first light flux entering into the objective lens as a divergent light flux on the information recording surface of the first optical information recording medium through the first protective substrate and converging the second light flux entering into the objective lens as a divergent light flux on the information recording surface of the second optical information recording medium through the second protective substrate, wherein the first optical surface of the objective lens comprises a spherical aberration correcting structure for correcting a spherical aberration caused by a thickness difference between the first protective substrate and the second protective substrate, the objective lens has an astigmatism for the first light flux, and the objective lens is arranged in the optical pickup apparatus such that the astigmatism of the objective lens for the first light flux reduces an astigmatism for the first light flux caused by a tracking operation of the objective lens and is arranged in the optical pickup apparatus such that the astigmatism of the objective lens has a minimum value when an image height of the objective lens along a tracking direction is in a range of 0.30Y-0.95Y, where Y is an image height of the objective lens when a tracking operation amount has a maximum value.

The structure described in Item 21 makes it possible to obtain the same effect as in Item 1.

Item 22

The structure described in Item 22 is the objective lens according to Item 21, for use in the optical pickup apparatus which satisfies 0.05 mm≦d≦0.15 mm, where d is a distance between emitting points of the first light source and the second light source, wherein the first light source and the second light source are arranged in the optical pickup apparatus such that a distance along an optical axis from the emitting point of the first light source to a surface of the first optical information recording medium facing the objective lens is equal to a distance along the optical axis from the emitting point of the second light source to a surface of the second optical information recording medium facing the objective lens.

The invention described in Item 22 makes it possible to obtain the same effect as in Item 2.

Item 23

The structure described in Item 23 is the objective lens according to Item 21 or Item 22, wherein the first optical surface of the objective lens comprises an astigmatism providing structure for providing an astigmatism for the first light flux to the objective lens.

Item 24

The structure described in Item 24 is the objective lens according to Item 23, wherein the astigmatism providing structure is formed by a shape of a basic asphecric surface of the objective lens.

Item 25

The structure described in Item 25 is the objective lens according to Item 24, wherein the spherical aberration correcting structure is a diffractive structure.

Item 26

The structure described in Item 26 is the objective lens according to Item 25, wherein the diffractive structure comprises diffractive ring-shaped zones and has a serrated sectional form.

The structures described in Items 24-26 make it possible to obtain the same effect as in Items 4-6.

Item 27

The structure described in Item 27 is the objective lens according to Item 23, wherein the astigmatism providing structure further provides an astigmatism for the second light flux to the objective lens, and the objective lens is arranged in the optical pickup apparatus such that the astigmatism of the objective lens for the second light flux reduces an astigmatism for the second light flux caused by a tracking operation of the objective lens and is arranged in the optical pickup apparatus such that the astigmatism for the second light flux of the objective lens has a minimum value when the image height of the objective lens along a tracking direction is in a range of 0.30Y-0.95Y.

Item 28

The structure described in Item 28 is the objective lens according to Item 27, the astigmatism providing structure is arranged such that the astigmatism providing structure provides predefined astigmatism amounts for the first light flux and the second light flux respectively to the objective lens.

Item 29

The structure described in Item 29 is the objective lens according to Item 28, wherein the astigmatism providing structure is a diffractive structure.

Item 30

The structure described in Item 30 is the objective lens according to Item 29, wherein the diffractive structure comprises diffractive ring-shaped zones and has a serrated sectional form.

Item 31

The structure described in Item 31 is the objective lens according to Item 30, wherein the diffractive ring-shaped zones have elliptic shapes.

Item 32

The structure described in Item 32 is the objective lens according to Item 21, wherein the second optical surface of the objective lens comprises an astigmatism providing structure for the first light flux to the objective lens.

Item 33

The structure described in Item 33 is the objective lens according to Item 32, wherein the astigmatism providing structure is formed by a shape of a basic asphecric surface of the objective lens.

The structure described in Item 33 makes it possible to obtain the same effect as in Item 13.

Item 34

The structure described in Item 34 is the objective lens according to Item 32, wherein the astigmatism providing structure further provides an astigmatism for the second light flux and the objective lens is arranged in the optical pickup apparatus such that the astigmatism of the objective lens for the second light flux reduces an astigmatism for the second light flux caused by a tracking operation of the objective lens and is arranged in the optical pickup apparatus such that the astigmatism for the second light flux of the objective lens has a minimum value when the image height of the objective lens along a tracking direction is in a range of 0.30Y-0.95Y.

Item 35

The structure described in Item 35 is the objective lens according to Item 34, wherein the astigmatism providing structure is arranged such that the astigmatism providing structure provides predefined astigmatism amounts for a light flux with the first light flux and the second light flux respectively to the objective lens.

The structures described in Items 34 and 35 make it possible to obtain the same effect as in Items 14-15.

Item 36

The structure described in Item 36 is the objective lens according to Item 35, wherein the astigmatism providing structure is a diffractive structure.

Item 37

The structure described in Item 37 is the objective lens according to Item 36, wherein the diffractive structure is a straight-line shaped diffractive structure.

Item 38

The structure described in Item 38 is the objective lens according to any one of Items 21-37, wherein the spherical aberration correcting structure is a diffractive structure.

Item 39

The structure described in Item 39 is the objective lens according to any one of Items 21-38, wherein the diffractive structure comprises diffractive ring-shaped zones and has a serrated sectional form.

Item 40

The structure described in Item 40 is the objective lens according to Item 21, wherein the objective lens is arranged in the optical pickup apparatus such that the astigmatism of the objective lens has a direction to reduce astigmatism caused by the first light flux because of a tracking operation and an astigmatism caused by an astigmatism difference of the first light source.

The structure described in Item 40 makes it possible to obtain the same effect as in Item 20.

Item 41

The structure described in Item 41 is provided with the optical pickup apparatus according to any one of Items 1-20, and it can conduct at least one of recording of information for the optical information recording medium and reproducing of information recorded on the optical information recording medium.

The structure described in Item 41 makes it possible to obtain an optical information recording and reproducing apparatus having the same effect as in any one of Items 1-20.

In the invention, it is possible to obtain an objective lens of a finite conjugate type which has compatibility for plural optical disks and can correct astigmatism caused by tracking and astigmatism owned by a light source itself, an optical pickup apparatus equipped with the aforementioned objective lens and an optical information recording and reproducing apparatus.

Preferred embodiments for practicing the invention will be explained in detail as follows, referring to the drawings.

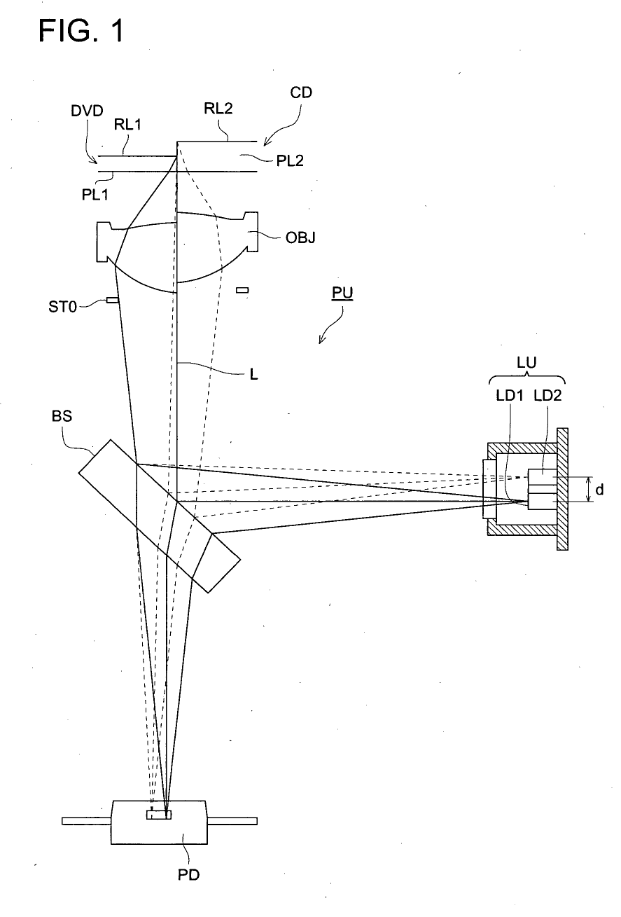

FIG. 1 is a diagram showing schematically the structure of optical pickup apparatus PU capable of conducting recording/reproducing of information properly for both of DVD (first optical information recording medium) and CD (second optical information recording medium). Optical specifications of DVD include wavelength λ1=655 nm, protective layer PL1 thickness t2=0.6 mm and numerical aperture NA1=0.60, while optical specifications of CD include wavelength λ2=785 nm, protective layer PL2 thickness t2=1.2 mm and numerical aperture NA2=0.47. However, a combination of a wavelength, a thickness of a protective layer and a numerical aperture is not limited to the foregoing.

The optical pickup apparatus PU is composed of packaged multiple light source unit LU wherein red semiconductor laser LD1 (first light source) that emits a laser light flux (first light flux) with 655 nm when conducting recording/reproducing of information for DVD and infrared semiconductor laser LD2 (second light source) that emits a laser light flux (second light flux) with 785 nm when conducting recording/reproducing of information for CD are united solidly, photodetector PD that is used commonly for the first light flux and the second light flux, objective lens OBJ having functions to converge light fluxes respectively on information recording surface RL1 and on information recording surface RL2, beam splitter BS and diaphragm STO.

In the packaged multiple light source unit LU, distance d between the light-emitting point of the first light source and the light-emitting point of the second light source is within a range of 0.05 mm≦d≦0.15 mm. Further, the packaged multiple light source unit LU is located in the optical system so that a distance on the optical axis from the light-emitting point of the first light source to the surface of DVD closer to objective lens OBJ may be the same as a distance on the optical axis from the light-emitting point of the second light source to the surface of CD closer to objective lens OBJ. Thus, a structure of a finite conjugate system wherein both the first light flux and the second light flux enter the objective lens OBJ as a divergent light is organized.

The objective lens OBJ has a spherical aberration correcting structure that corrects spherical aberration caused by a difference between protective substrate thickness t1 and protective substrate thickness t2. As the spherical aberration correcting structure, there are given, for example, diffractive structures such as diffractive ring-shaped zones whose sectional view is in serration and diffractive gratings.

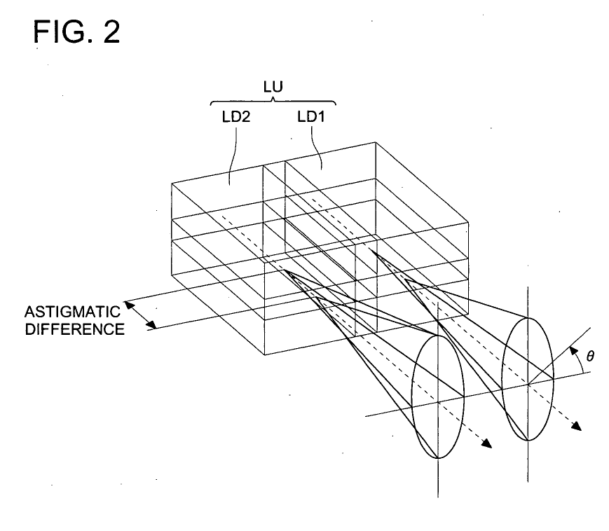

As shown in FIG. 2, astigmatism is caused by an astigmatic difference owned by red semiconductor laser LD1 itself that emits the first light flux, and astigmatism is caused also by tracking. Therefore, in the invention, objective lens OBJ is designed so that it has prescribed astigmatism to reduce the aforementioned astigmatisms.

Incidentally, in the present embodiment and in the example which will be described later, the direction satisfying θ=0 in FIG. 2 is made to be the tracking direction.

Specifically, objective lens OBJ is designed so that astigmatism owned by the objective lens OBJ itself for the first light flux with wavelength λ1 may take the minimum value, in the range of 0.30Y to 0.95Y for the image height of the objective lens OBJ in the tracking direction, when Y represents an image height of objective lens OBJ in the case of the maximum amount of tracking. As the structure that causes objective lens OBJ to have astigmatism, there are given, for example, a structure wherein a curvature in a basic aspheric surface of the horizontal direction on a plane of emergence is different, in terms of value, from that in the vertical direction on a plane of emergence, and a structure wherein an orientation strain is caused by resin molding on objective lens OBJ. Incidentally, when the objective lens OBJ is made to have astigmatism by making a curvature in the basic aspheric surface of the horizontal direction to be different, in terms of value, from that in the vertical direction, it is preferable to form the spherical aberration correcting structure on a plane of incidence or emergence of the objective lens OBJ. Due to this, design of objective lens OBJ turns out to be easy.

Further, the objective lens OBJ is arranged in the optical system so that a light convergence point on the surface formed by the direction of astigmatism owned by objective lens OBJ itself and by the normal line on the surface of DVD closer to the objective lens OBJ may be formed to be behind of a light convergence point in the plane that is perpendicular to the above-mentioned surface.

Due to the foregoing, astigmatism caused by red semiconductor laser LD1 and astigmatism caused tracking are reduceed, and thereby, astigmatism is properly corrected as the total optical system, even when the objective lens OBJ is shifted from the optical axis in the case of tracking.

Incidentally, astigmatism that is caused when astigmatism caused by semiconductor laser and astigmatism caused by tracking are composed, and a method of designing objective lens OBJ for correcting the aforesaid astigmatism are described in Japanese Patent No. 3191200 (Patent Document 2), and therefore, an explanation for them will be omitted here.

In the invention as stated above, astigmatism of the first light flux with wavelength λ1 caused by tracking and astigmatism caused by an astigmatic difference owned by the first light source that emits the first light flux (hereinafter, these two astigmatism are indicated as “astigmatism concerning the first light flux” or “astigmatism for the first light flux”) are reduced by astigmatism which the objective lens OBJ has for the first light flux.

Therefore, with respect to astigmatism of the second light flux with wavelength λ2 caused by tracking and astigmatism caused by an astigmatic difference owned by the second light source that emits the second light flux (hereinafter, these two astigmatism are indicated as “astigmatism concerning the second light flux” or “astigmatism for the second light flux”), they are not corrected on the same level as that in the astigmatism relating to the first light flux.

However, the direction of occurrence of astigmatism concerning the second light flux agrees substantially with the direction of occurrence of astigmatism concerning the first light flux. Accordingly, an amount of occurrence of astigmatism concerning the second light flux can be corrected even by astigmatism which the objective lens OBJ has for the first light flux with wavelength λ1 to the level where there is no trouble in practical use.

Therefore, with respect to astigmatism concerning the second light flux, an optical element having wavelength selectivity capable of correcting positively the astigmatism concerning the second light flux may be added to the optical system of the optical pickup apparatus, or the wavelength selectivity may be added to the objective lens OBJ itself, in accordance with specifications required for the optical pickup apparatus.

As a method to cause the objective lens OBJ to have wavelength selectivity which give an optional amount of astigmatism to each of the first light flux with wavelength λ1 and the second light flux with wavelength λ2 respectively, there is given, for example, a method to form an elliptic-shaped diffractive structure or a straight-line-shaped diffractive structure.

Incidentally, it is also possible to employ the structure wherein only astigmatism of the first light flux with wavelength λ1 caused by tracking is reduced by astigmatism which the objective lens OBJ has for the first lens flux.

When conducting recording/reproducing of information for DVD, in optical pickup apparatus PU, red semiconductor laser LD1 is first made to emit light as its light path is drawn with solid lines in FIG. 1. A divergent light flux emitted from the red semiconductor laser LD1 is reflected on beam splitter BS and arrives at the objective lens OBJ.

Then, a diffracted light with prescribed number of order of the first light flux generated when receiving diffractive actions from the diffractive structure representing a spherical aberration correcting structure that is formed on a plane of incidence of the objective lens OBJ is converged on information recording surface RL1 through protective layer PL1 of DVD, to form a spot.

Then, the objective lens OBJ is made to conduct focusing and tracking by biaxial actuator AC (not shown) arranged around the objective lens OBJ. The reflected light flux modulated by information pits on the information recording surface RL1 passes, and passes through the beam splitter BS to be converged on a light-receiving surface of photodetector PD. Thus, it is possible to read information recorded on DVD by the use of output signals from the photodetector PD.

When conducting recording/reproducing of information for CD, infrared semiconductor laser LD2 is first made to emit light as its light path is drawn with dotted lines in FIG. 1. A divergent light flux emitted from the infrared semiconductor laser LD2 is reflected on beam splitter BS and arrives at the objective lens OBJ.

Then, a diffracted light with prescribed number of order of the second light flux generated when receiving diffractive actions from the diffractive structure representing a spherical aberration correcting structure that is formed on a plane of incidence of the objective lens OBJ is converged on information recording surface RL2 through protective layer PL2 of CD, to form a spot.

Then, the objective lens OBJ is made to conduct focusing and tracking by biaxial actuator AC (not shown) arranged around the objective lens OBJ. The reflected light flux modulated by information pits on the information recording surface RL2 passes, and passes through the beam splitter BS to be converged on a light-receiving surface of photodetector PD. Thus, it is possible to read information recorded on CD by the use of output signals from the photodetector PD.

Incidentally, it is possible to obtain an optical information recording and reproducing apparatus capable of conducting at least one of recording of information for an optical information recording medium and reproducing of information recorded on an optical information recording medium, by installing optical pickup apparatus PU shown in the aforesaid embodiment, a rotary driving apparatus that holds an optical information recording medium rotatably and a control device that controls driving of the aforementioned apparatuses, which, however, are not illustrated.

### EXAMPLE 1

Next, first examples for the objective lens and the optical pickup apparatus shown in the aforementioned embodiment will be explained.

Table 1 and Table 2 show lens data of each optical element.

TABLE 1

| | | |
|---|---|---|
| f = 2.29 mm | m = −1/7 | NA = 0.60 |

| i^{th} | | di | ni | di | ni | |
|---|---|---|---|---|---|---|
| sur- | | (655 | (655 | (785 | (785 | |
| face | ri | nm) | nm) | nm) | nm) | |
| 0 | | 10.000 | | 10.000 | | |
| 1 | ∞ | 1.250 | 1.5070 | 1.250 | 1.5070 | |
| 2 | ∞ | 7.042 | 1.0000 | 7.416 | 1.0000 | |
| 3 | ∞ | 0.000 | 1.0000 | 0.000 | 1.0000 | Diaphragm |
| | | | | | | diameter |
| | | | | | | φ3.075 mm |
| 4 | 1.57913 | 1.780 | 1.5409 | 1.780 | 1.5372 | |
| 4′ | 1.82253 | | | | | |
| 5 | −3.44407 | 1.328 | 1.0000 | 1.954 | 1.0000 | |
| 5′ | −3.76202 | | | | | |
| 6 | ∞ | 0.600 | 1.5775 | 1.200 | 1.5706 | |
| 7 | ∞ | | | | | |

Astigmatic difference DVD = 0 μm, CD = 0 μm

TABLE 2
Aspheric surface data

| 4^{th} surface | | |
|---|---|---|
| (0 ≦ h < 1.245 mm: Common area for DVD/CD) | | |
| Aspheric surface coefficient | κ | −5.9547 × E−1 |
| | A4 | −7.8536 × E−3 |
| | A6 | −2.2592 × E−3 |
| | A8 | −1.4896 × E−3 |
| | A10 | −8.6859 × E−4 |
| | A12 | +3.0411 × E−3 |
| | A14 | −1.1970 × E−3 |
| Optical path difference | B4 | −3.6858 × E−3 |
| function (Coefficient of | B6 | −1.0370 × E−3 |
| optical path difference | B8 | +9.6293 × E−4 |
| function: λB 720 nm first | B10 | −3.2649 × E−4 |
| order diffraction) | | |
| 4′^{th} surface | | |
| (1.245 mm ≦ h: Exclusive area for DVD) | | |
| Aspheric surface coefficient | κ | −4.6344 × E−1 |
| | A0 | +1.6824 × E−2 |
| | A4 | +2.4963 × E−2 |
| | A6 | −8.8957 × E−3 |
| | A8 | −7.6358 × E−4 |
| | A10 | +1.0887 × E−4 |
| | A12 | +3.7918 × E−4 |
| | A14 | −1.0592 × E−4 |
| Optical path difference | B2 | −1.6983 × E−3 |
| function (Coefficient of | B4 | −2.2906 × E−4 |
| optical path difference | B6 | +2.0581 × E−4 |
| function: λB 655 nm third | B8 | −1.3305 × E−4 |
| order diffraction) | B10 | +1.4272 × E−5 |
| 5^{th} surface | | |
| (0 ≦ h < 0.955 mm: Common area for DVD/CD) | | |
| Aspheric surface coefficient | κ | −3.3888 × E+0 |
| | A4 | +4.9707 × E−2 |
| | A6 | −2.9863 × E−2 |
| | A8 | −5.4839 × E−2 |
| | A10 | +1.7138 × E−1 |
| | A12 | −1.5035 × E−1 |
| | A14 | +4.2400 × E−2 |
| | C | −2.3429 × E−5 |
| 5′^{th} surface | | |
| (0.955 mm ≦ h: Exclusive area for DVD) | | |
| Aspheric surface coefficient | κ | −6.2192 × E+0 |
| | A4 | +1.3082 × E−2 |
| | A6 | −1.8328 × E−3 |
| | A8 | +2.1644 × E−3 |
| | A10 | −1.2220 × E−3 |
| | A12 | +3.2728 × E−5 |
| | A14 | +2.8465 × E−5 |
| | C | −2.3429 × E−5 |

As shown in Table 1, the objective lens in the present example is established to have focal length f=2.29 mm, image-side numerical aperture NA=0.60 and optical system magnification m=−1/7. In the Table 1, ri represents a radius of curvature, di represents an amount of displacement from i^{th} surface to (i+1)^{th} surface in the optical axial direction and ni represents a refractive index of each surface.

In the present example, neither the first light source for DVD nor the second light source for CD has an astigmatic difference (“Astigmatic difference DVD=0 μm, CD=0 μm” is inscribed in Table 1).

A plane of incidence of the objective lens is divided into the 4^{th} surface whose height from the optical axis is less than 1.245 mm and the 4′^{th} surface whose height from the optical axis is not less than 1.245 mm. A plane of emergence of the objective lens is divided into the 5^{th} surface whose height from the optical axis is less than 0.955 mm and the 5′^{th} surface whose height from the optical axis is not less than 0.955 mm.

The 4′^{th} surface and the 5′^{th} surface represent an area that is used exclusively by the first light flux used for DVD, and the second light flux which has passed through the 4′^{th} surface and the 5′^{th} surface is not used for recording/reproducing of information for CD.

The 4^{th} surface and the 4′^{th} surface are formed to be aspheric surfaces which stipulated by the expression wherein coefficients shown in the Tables 1 and 2 are respectively substituted in the following expression (Numeral 1), and are axially symmetrical around optical axis L.

(Numeral 1)

Expression of aspheric surface form

$$X ( h ) = \frac{( {h}^{2} / R )}{1 + \sqrt{1 - ( 1 + κ ) {( h / R )}^{2}}} + {\sum }_{i = 0}^{9} + {A}_{2 i} {h}^{2 i}$$

In the expression above, X(h) represents an axis (direction for light to advance is positive) in the axial direction, κ represents a conic constant and A₂ᵢ represents an aspheric surface coefficient.

Further, on each of the 4^{th} surface and the 4′^{th} surface, there are formed serrated and diffractive ring-shaped zones representing a spherical aberration correcting structure. A pitch of the diffractive ring-shaped zones is stipulated by the expression wherein coefficients shown in the Table 2 are substituted in the following Numeral 2 that is an optical path difference function.

(Numeral 2)

Expression of optical path difference function

$$ϕ ( h ) = ( {\sum }_{i = 0}^{5} {B}_{2 i} {h}^{2 i} ) \times n \times λ / λ B$$

In the expression above, B₂ᵢ represents a coefficient of the optical path difference function, λ represents a working wavelength, λB represents a blazed wavelength for diffraction and n represents the number of order for diffraction.

The 5^{th} surface and the 5′^{th} surface are formed respectively to be non-rotary symmetrical aspheric surfaces which are stipulated by the expression wherein coefficients shown in the Table 2 are substituted in the following expression (Numeral 3).

(Numeral 3)

Expression of form: Rotary symmetrical aspheric surface+non-rotary symmetrical aspheric surface

$$z = [ \frac{{h}^{2} / R}{1 + \sqrt{1 - ( 1 + κ ) {h}^{2} / {R}^{2}}} + {\sum }_{i = 0}^{7} {A}_{2 i} {h}^{2 i} ] + {Ch}^{2} cos 2 θ$$

where (h, θ) is a polar coordinate whose origin is centered on an optical axis.

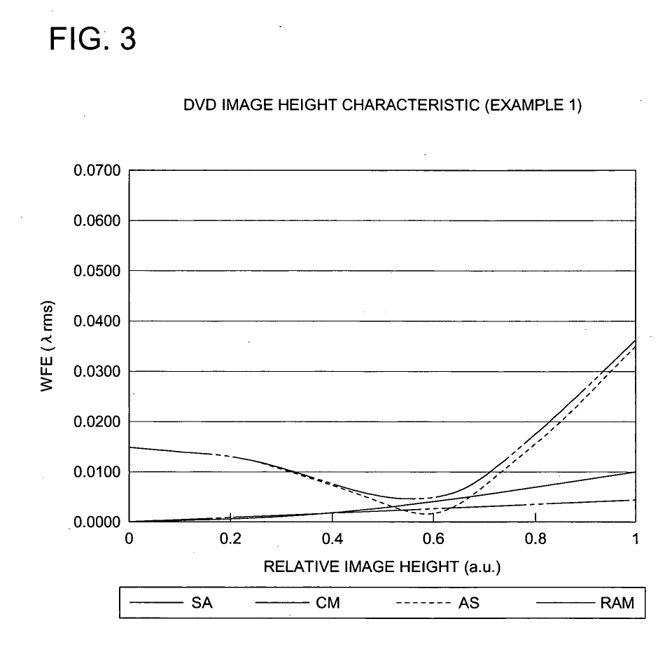

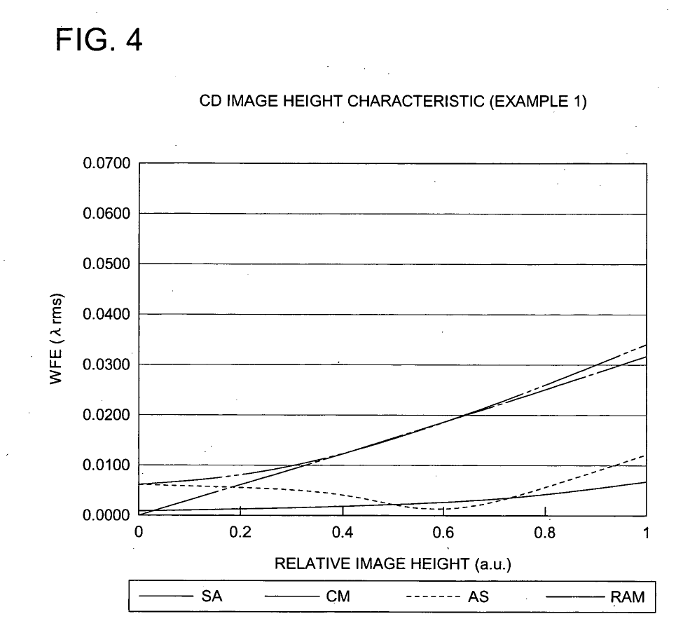

Each of FIG. 3 and FIG. 4 is a graph showing image heights characteristics respectively for DVD and CD in the case of using the objective lens and the optical pickup apparatus in the present example.

The vertical axis of the graph shows an amount of wavefront aberration and the horizontal axis of the graph shows a relative image height wherein the relative image height is 1 when the sum total including an object height and an image height is 0.45 mm. “Image height Y of the objective lens when a tracking operation amount has a maximum value” in the invention corresponds to relative image height=1. The direction of tracking (image height) is the direction of θ=0°.

Further, SA represents spherical aberration, CM represents coma, AS represents astigmatism, and RMS represents a value of the total of these aberrations.

As is clear from FIG. 3, the objective lens itself has astigmatism of about 0.015 λrms for the first light flux with wavelength λ1, and is designed so that its astigmatism may show the minimum value in the vicinity of 0.6Y of the image height in the tracking direction.

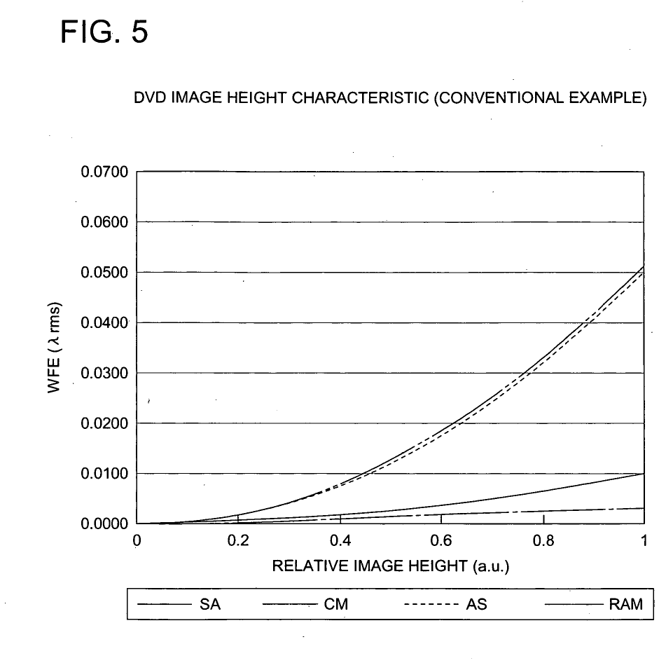

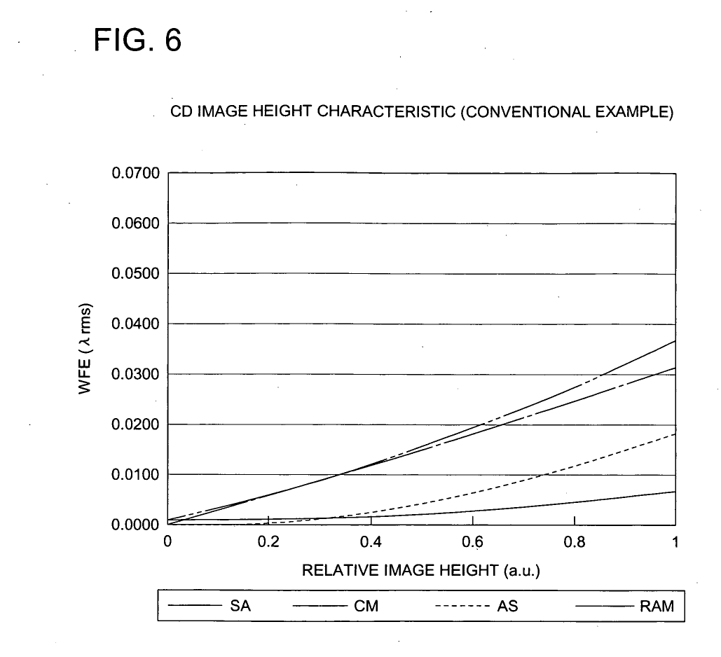

FIG. 5 and FIG. 6 are graphs showing the structures of the conventional objective lens and the optical pickup apparatus, namely, the image height characteristics respectively of DVD and CD in the case where the objective lens itself has no astigmatism.

When comparing FIG. 3 with FIG. 5, and comparing FIG. 4 with FIG. 6, it is understood that the wavefront aberration is controlled to be of the low value in the total area for the relative image height from 0 to 1, in the objective lens and the optical pickup apparatus in the present example.

### EXAMPLE 2

Next, first examples for the objective lens and the optical pickup apparatus shown in the aforementioned embodiment will be explained.

Table 3 and Table 4 show lens data of each optical element.

TABLE 3

| | | |
|---|---|---|
| f = 2.29 mm | m = −1/7 | NA = 0.60 |

| i^{th} | | di | ni | di | ni | |
|---|---|---|---|---|---|---|
| sur- | | (655 | (655 | (785 | (785 | |
| face | ri | nm) | nm) | nm) | nm) | |
| 0 | | 10.000 | | 10.000 | | |
| 1 | ∞ | 1.250 | 1.5070 | 1.250 | 1.5070 | |
| 2 | ∞ | 7.042 | 1.0000 | 7.416 | 1.0000 | |
| 3 | ∞ | 0.000 | 1.0000 | 0.000 | 1.0000 | Diaphragm |
| | | | | | | diameter |
| | | | | | | φ3.075 mm |
| 4 | 1.57913 | 1.780 | 1.5409 | 1.780 | 1.5372 | |
| 4′ | 1.82253 | | | | | |
| 5 | −3.44407 | 1.328 | 1.0000 | 1.954 | 1.0000 | |
| 5′ | −3.76202 | | | | | |
| 6 | ∞ | 0.600 | 1.5775 | 1.200 | 1.5706 | |
| 7 | ∞ | | | | | |

Astigmatic difference DVD = 0 μm, CD = 0 μm

TABLE 4
Aspheric surface data

| 4^{th} surface | | |
|---|---|---|
| (0 ≦ h < 1.245 mm: Common area for DVD/CD) | | |
| Aspheric surface coefficient | κ | −5.9547 × E−1 |
| | A4 | −7.8536 × E−3 |
| | A6 | −2.2592 × E−3 |
| | A8 | −1.4896 × E−3 |
| | A10 | −8.6859 × E−4 |
| | A12 | +3.0411 × E−3 |
| | A14 | −1.1970 × E−3 |
| Optical path difference | B4 | −3.6858 × E−3 |
| function (Coefficient of | B6 | −1.0370 × E−3 |
| optical path difference | B8 | +9.6293 × E−4 |
| function: λB 720 nm first | B10 | −3.2649 × E−4 |
| order diffraction) | | |
| 4′^{th} surface | | |
| (1.245 mm ≦ h: Exclusive area for DVD) | | |
| Aspheric surface coefficient | κ | −4.6344 × E−1 |
| | A0 | +1.6824 × E−2 |
| | A4 | +2.4963 × E−2 |
| | A6 | −8.8957 × E−3 |
| | A8 | −7.6358 × E−4 |
| | A10 | +1.0887 × E−4 |
| | A12 | +3.7918 × E−4 |
| | A14 | −1.0592 × E−4 |
| Optical path difference | B2 | −1.6983 × E−3 |
| function (Coefficient of | B4 | −2.2906 × E−4 |
| optical path difference | B6 | +2.0581 × E−4 |
| function: λB 655 nm third | B8 | −1.3305 × E−4 |
| order diffraction) | B10 | +1.4272 × E−5 |
| 5^{th} surface | | |
| (0 ≦ h < 0.955 mm: Common area for DVD/CD) | | |
| Aspheric surface coefficient | κ | −3.3888 × E+0 |
| | A4 | +4.9707 × E−2 |
| | A6 | −2.9863 × E−2 |
| | A8 | −5.4839 × E−2 |
| | A10 | +1.7138 × E−1 |
| | A12 | −1.5035 × E−1 |
| | A14 | +4.2400 × E−2 |
| | C | −4.6859 × E−5 |
| 5′^{th} surface | | |
| (0.955 mm ≦ h: Exclusive area for DVD) | | |
| Aspheric surface coefficient | κ | −6.2192 × E+0 |
| | A4 | +1.3082 × E−2 |
| | A6 | −1.8328 × E−3 |
| | A8 | +2.1644 × E−3 |
| | A10 | −1.2220 × E−3 |
| | A12 | +3.2728 × E−5 |
| | A14 | +2.8465 × E−5 |
| | C | −4.6859 × E−5 |

As shown in Table 3, the objective lens in the present example is established to have focal length f=2.29 mm, image-side numerical aperture NA=0.60 and optical system magnification m=−1/7.

In the present example again, neither the first light source for DVD nor the second light source for CD has an astigmatic difference (“Astigmatic difference DVD=0 μm, CD=0 μm” is inscribed in Table 3).

A plane of incidence of the objective lens is divided into the 4^{th} surface whose height from the optical axis is less than 1.245 mm and the 4′^{th} surface whose height from the optical axis is not less than 1.245 mm. A plane of emergence of the objective lens is divided into the 5^{th} surface whose height from the optical axis is less than 0.955 mm and the 5′^{th} surface whose height from the optical axis is not less than 0.955 mm.

The 4′^{th} surface and the 5′^{th} surface represent an area that is used exclusively by the first light flux used for DVD, and the second light flux which has passed through the 4′^{th} surface and the 5′^{th} surface is not used for recording/reproducing of information for CD.

The 4^{th} surface and the 4′^{th} surface are formed to be aspheric surfaces which stipulated by the expression wherein coefficients shown in the Tables 3 and 4 are respectively substituted in the Numeral 1, and are axially symmetrical around optical axis L.

Further, on each of the 4^{th} surface and the 4′^{th} surface, there are formed serrated and diffractive ring-shaped zones representing a spherical aberration correcting structure. A pitch of the diffractive ring-shaped zones is stipulated by the expression wherein coefficients shown in the Table 4 are substituted in the following Numeral 2 that is an optical path difference function.

The 5^{th} surface and the 5′^{th} surface are formed respectively to be non-rotary symmetrical aspheric surfaces which are stipulated by the expression wherein coefficients shown in the Table 4 are substituted in the Numeral 3.

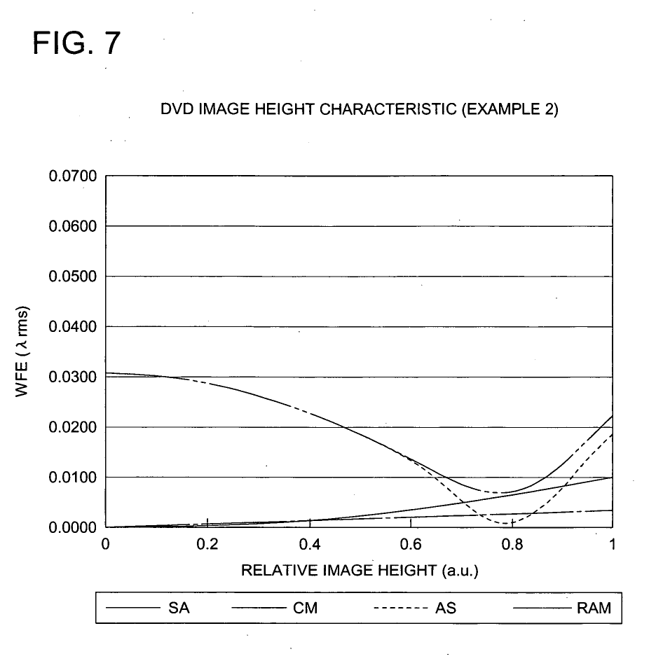

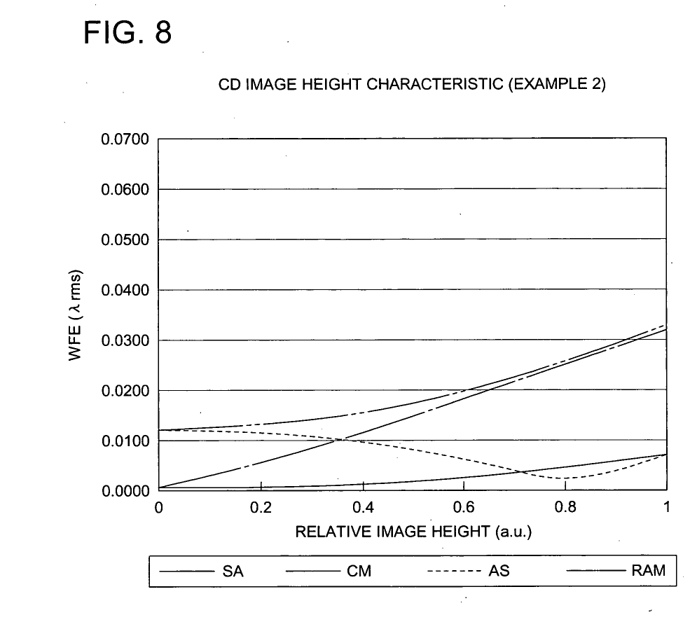

Each of FIG. 7 and FIG. 8 is a graph showing image heights respectively for DVD and CD in the case of using the objective lens and the optical pickup apparatus in the present example.

As is clear from FIG. 7, the objective lens itself has astigmatism of about 0.03 λrms for the first light flux with wavelength λ1, and is designed so that its astigmatism may show the minimum value in the vicinity of 0.8Y of the image height in the tracking direction.

When comparing FIG. 7 with FIG. 5, and comparing FIG. 8 with FIG. 6, it is understood that the wavefront aberration is controlled to be of the low value in the total area for the relative image height from 0 to 1, in the objective lens and the optical pickup apparatus in the present example.

### EXAMPLE 3

Next, third examples for the objective lens and the optical pickup apparatus shown in the aforementioned embodiment will be explained.

Table 5 and Table 6 show lens data of each optical element.

TABLE 5

| | | |
|---|---|---|
| f = 2.29 mm | m = −1/7 | NA = 0.60 |

| i^{th} | | di | ni | di | ni | |
|---|---|---|---|---|---|---|
| sur- | | (655 | (655 | (785 | (785 | |
| face | ri | nm) | nm) | nm) | nm) | |
| 0 | | 10.000 | | 10.000 | | |
| 1 | ∞ | 1.250 | 1.5070 | 1.250 | 1.5070 | |
| 2 | ∞ | 7.042 | 1.0000 | 7.416 | 1.0000 | |
| 3 | ∞ | 0.000 | 1.0000 | 0.000 | 1.0000 | Diaphragm |
| | | | | | | diameter |
| | | | | | | φ3.075 mm |
| 4 | 1.57913 | 1.780 | 1.5409 | 1.780 | 1.5372 | |
| 4′ | 1.82253 | | | | | |
| 5 | −3.44407 | 1.328 | 1.0000 | 1.954 | 1.0000 | |
| 5′ | −3.76202 | | | | | |
| 6 | ∞ | 0.600 | 1.5775 | 1.200 | 1.5706 | |
| 7 | ∞ | | | | | |

Astigmatic difference DVD = 10 μm, CD = 10 μm

TABLE 6

| 4^{th} surface | | |
|---|---|---|
| (0 ≦ h < 1.245 mm: Common area for DVD/CD) | | |
| Aspheric surface coefficient | κ | −5.9547 × E−1 |
| | A4 | −7.8536 × E−3 |
| | A6 | −2.2592 × E−3 |
| | A8 | −1.4896 × E−3 |
| | A10 | −8.6859 × E−4 |
| | A12 | +3.0411 × E−3 |
| | A14 | −1.1970 × E−3 |
| Optical path difference | B4 | −3.6858 × E−3 |
| function (Coefficient of | B6 | −1.0370 × E−3 |
| optical path difference | B8 | +9.6293 × E−4 |
| function: λB 720 nm first | B10 | −3.2649 × E−4 |
| order diffraction) | | |
| 4′^{th} surface | | |
| (1.245 mm ≦ h: Exclusive area for DVD) | | |
| Aspheric surface coefficient | κ | −4.6344 × E−1 |
| | A0 | +1.6824 × E−2 |
| | A4 | +2.4963 × E−2 |
| | A6 | −8.8957 × E−3 |
| | A8 | −7.6358 × E−4 |
| | A10 | +1.0887 × E−4 |
| | A12 | +3.7918 × E−4 |
| | A14 | −1.0592 × E−4 |
| Optical path difference | B2 | −1.6983 × E−3 |
| function (Coefficient of | B4 | −2.2906 × E−4 |
| optical path difference | B6 | +2.0581 × E−4 |
| function: λB 655 nm third | B8 | −1.3305 × E−4 |
| order diffraction) | B10 | +1.4272 × E−5 |
| 5^{th} surface | | |
| (0 ≦ h < 0.955 mm: Common area for DVD/CD) | | |
| Aspheric surface coefficient | κ | −3.3888 × E+0 |
| | A4 | +4.9707 × E−2 |
| | A6 | −2.9863 × E−2 |
| | A8 | −5.4839 × E−2 |
| | A10 | +1.7138 × E−1 |
| | A12 | −1.5035 × E−1 |
| | A14 | +4.2400 × E−2 |
| | C | −4.6859 × E−5 |
| 5′^{th} surface | | |
| (0.955 mm ≦ h: Exclusive area for DVD | | |
| Aspheric surface coefficient | κ | −6.2192 × E+0 |
| | A4 | +1.3082 × E−2 |
| | A6 | −1.8328 × E−3 |
| | A8 | +2.1644 × E−3 |
| | A10 | −1.2220 × E−3 |
| | A12 | +3.2728 × E−5 |
| | A14 | +2.8465 × E−5 |
| | C | −4.6859 × E−5 |

Incidentally, compared with the aforesaid example 2, the present example is different only on the point that both of the first light source for DVD and the second light source for CD have astigmatic difference of 10 μm (“Astigmatic difference DVD=10 μm, CD=10 μm” is inscribed in Table 5).

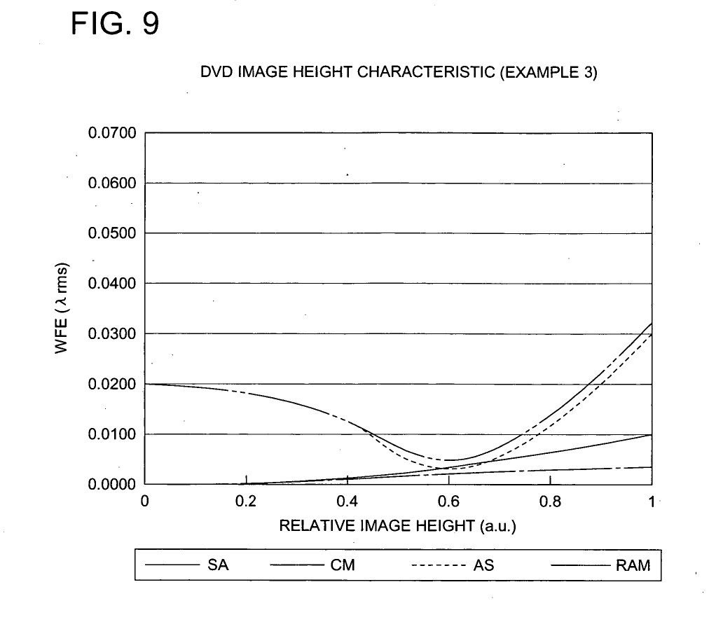

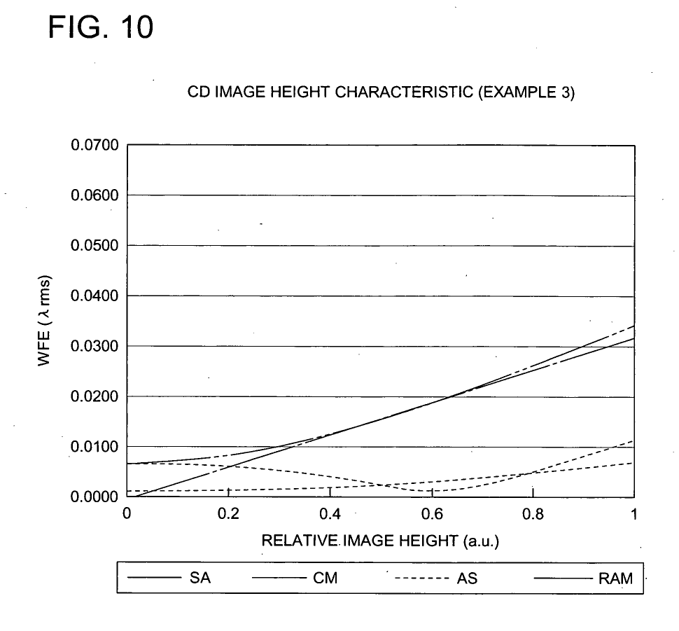

Each of FIG. 9 and FIG. 10 is a graph showing image heights characteristics respectively for DVD and CD in the case of using the objective lens and the optical pickup apparatus in the present example.

As is clear from FIG. 9, the objective lens itself has astigmatism of about 0.02 λrms for the first light flux with wavelength λ1, and is designed so that its astigmatism may show the minimum value in the vicinity of 0.6Y of the image height in the tracking direction.

When comparing FIG. 9 with FIG. 5, and comparing FIG. 10 with FIG. 6, it is understood that the wavefront aberration is controlled to be of the low value in the total area for the relative image height from 0 to 1, in the objective lens and the optical pickup apparatus in the present example.

1. An optical pickup apparatus for recording and/or reproducing information on a first optical information recording medium whose information recording surface has a first protective substrate with a thickness t1 and a second optical information recording medium whose information recording surface has a second protective substrate with a thickness t2 (t1<t2), the optical pickup apparatus comprising:
a first light source emitting a first light flux with a wavelength λ1;
a second light source emitting a second light flux with a wavelength λ2 (λ1<λ2); and
an objective lens having a first optical surface and a second optical surface arranged on an opposite side to the first optical surface of the objective lens, converging the first light flux entering into the objective lens as a divergent light flux on the information recording surface of the first optical information recording medium through the first protective substrate and converging the second light flux entering into the objective lens as a divergent light flux on the information recording surface of the second optical information recording medium through the second protective substrate,
wherein the first optical surface of the objective lens comprises a spherical aberration correcting structure for correcting a spherical aberration caused by a thickness difference between the first protective substrate and the second protective substrate,
the objective lens has an astigmatism for the first light flux, and
the objective lens is arranged in the optical pickup apparatus such that the astigmatism of the objective lens has a minimum value when an image height of the objective lens along a tracking direction is in a range of 0.30Y-0.95Y, where Y is an image height of the objective lens when a tracking operation amount has a maximum value.

2. The image pickup apparatus of claim 1,
wherein the image pickup apparatus satisfies 0.05 mm≦d≦0.15 mm, where d is a distance between emitting points of the first light source and the second light source, and the first light source and the second light source are arranged in the optical pickup apparatus such that a distance along an optical axis from the emitting point of the first light source to a surface of the first optical information recording medium facing the objective lens is equal to a distance along the optical axis from the emitting point of the second light source to a surface of the second optical information recording medium facing the objective lens.

3. The optical pickup apparatus of claim 1,
wherein the first optical surface of the objective lens comprises an astigmatism providing structure for providing an astigmatism for the first light flux to the objective lens.

4. The optical pickup apparatus of claim 3,
wherein the astigmatism providing structure is formed by a shape of a basic asphecric surface of the objective lens.

5. The optical pickup apparatus of claim 4,
wherein the spherical aberration correcting structure is a diffractive structure.

6. The optical pickup apparatus of claim 5,
wherein the diffractive structure comprises diffractive ring-shaped zones and has a serrated sectional form.

7. The optical pickup apparatus of claim 3,
wherein the astigmatism providing structure further provides an astigmatism for the second light flux to the objective lens, and
the objective lens is arranged in the optical pickup apparatus such that the astigmatism for the second light flux of the objective lens has a minimum value when the image height of the objective lens along a tracking direction is in a range of 0.30Y-0.95Y.

8. The optical pickup apparatus of claim 7,
wherein the astigmatism providing structure is arranged such that the astigmatism providing structure provides predefined astigmatism amounts for the first light flux and the second light flux respectively to the objective lens.

9. The optical pickup apparatus of claim 8,
wherein the astigmatism providing structure is a diffractive structure.

10. The optical pickup apparatus of claim 9,
wherein the diffractive structure comprises diffractive ring-shaped zones and has a serrated sectional form.

11. The optical pickup apparatus of claim 10,
wherein the diffractive ring-shaped zones have elliptic shapes.

12. The optical pickup apparatus of claim 1,
wherein the second optical surface of the objective lens comprises an astigmatism providing structure for the first light flux to the objective lens.

13. The optical pickup apparatus of claim 12,
wherein the astigmatism providing structure is formed by a shape of a basic asphecric surface of the objective lens.

14. The optical pickup apparatus of claim 12,
wherein the astigmatism providing structure further provides an astigmatism for the second light flux and
the objective lens is arranged in the optical pickup apparatus such that the astigmatism for the second light flux of the objective lens has a minimum value when an image height along a tracking direction of the objective lens is in a range of 0.3Y-0.95Y.

15. The optical pickup apparatus of claim 14,
wherein the astigmatism providing structure is arranged such that the astigmatism providing structure provides predefined astigmatism amounts for a light flux with the first light flux and the second light flux respectively to the objective lens.

16. The optical pickup apparatus of claim 15,
wherein the astigmatism providing structure is a diffractive structure.

17. The optical pickup apparatus of claim 16,
wherein the diffractive structure is a diffractive structure having linear structures.

18. The optical pickup apparatus of claim 1,
wherein the spherical aberration correcting structure is a diffractive structure.

19. The optical pickup apparatus of claim 18,
wherein the diffractive structure comprises diffractive ring-shaped zones and has a serrated sectional form.

20. The optical pickup apparatus of claim 1,
wherein the objective lens is arranged in the optical pickup apparatus such that the astigmatism of the objective lens has a direction to reduce astigmatism caused by the first light flux because of a tracking operation and an astigmatism caused by an astigmatism difference of the first light source.

21. An objective lens for use in an optical pickup apparatus reproducing and/or recording information on a first optical information recording medium having a protective substrate with a thickness t1 by a first light flux with a wavelength λ1 emitted from a first light source and reproducing and/or recording information on a second optical information recording medium having a protective substrate with a thickness t2 (t1<t2) by a second light flux with a wavelength λ2 emitted from a second light source, the objective lens comprising:
a first optical surface and a second optical surface arranged on an opposite side to the first optical surface of the objective lens,
wherein the optical objective lens converges the first light flux entering into the objective lens as a divergent light flux on the information recording surface of the first optical information recording medium through the first protective substrate and converging the second light flux entering into the objective lens as a divergent light flux on the information recording surface of the second optical information recording medium through the second protective substrate,
wherein the first optical surface of the objective lens comprises a spherical aberration correcting structure for correcting a spherical aberration caused by a thickness difference between the first protective substrate and the second protective substrate,
the objective lens has an astigmatism for the first light flux, and
the objective lens is arranged in the optical pickup apparatus such that the astigmatism of the objective lens has a minimum value when an image height of the objective lens along a tracking direction is in a range of 0.30Y-0.95Y, where Y is an image height of the objective lens when a tracking operation amount has a maximum value.

22. The objective lens of claim 21 for use in the optical pickup apparatus which satisfies 0.05 mm≦d≦0.15 mm, where d is a distance between emitting points of the first light source and the second light source,
wherein the first light source and the second light source are arranged in the optical pickup apparatus such that a distance along an optical axis from the emitting point of the first light source to a surface of the first optical information recording medium facing the objective lens is equal to a distance along the optical axis from the emitting point of the second light source to a surface of the second optical information recording medium facing the objective lens.

23. The objective lens of claim 21,
wherein the first optical surface of the objective lens comprises an astigmatism providing structure for providing an astigmatism for the first light flux to the objective lens.

24. The objective lens of claim 23,
wherein the astigmatism providing structure is formed by a shape of a basic asphecric surface of the objective lens.

25. The objective lens of claim 24,
wherein the spherical aberration correcting structure is a diffractive structure.

26. The objective lens of claim 25,
wherein the diffractive structure comprises diffractive ring-shaped zones and has a serrated sectional form.

27. The objective lens of claim 23,
wherein the astigmatism providing structure further provides an astigmatism for the second light flux to the objective lens, and
the objective lens is arranged in the optical pickup apparatus such that the astigmatism for the second light flux of the objective lens has a minimum value when the image height of the objective lens along a tracking direction is in a range of 0.30Y-0.95Y.

28. The objective lens of claim 27,
wherein the astigmatism providing structure is arranged such that the astigmatism providing structure provides predefined astigmatism amounts for the first light flux and the second light flux respectively to the objective lens.

29. The objective lens of claim 28,
wherein the astigmatism providing structure is a diffractive structure.

30. The objective lens of claim 29,
wherein the diffractive structure comprises diffractive ring-shaped zones and has a serrated sectional form.

31. The objective lens of claim 30,
wherein the diffractive ring-shaped zones have elliptic shapes.

32. The objective lens of claim 21,
wherein the second optical surface of the objective lens comprises an astigmatism providing structure for the first light flux to the objective lens.

33. The objective lens of claim 32,
wherein the astigmatism providing structure is formed by a shape of a basic asphecric surface of the objective lens.

34. The objective lens of claim 32,
wherein the astigmatism providing structure further provides an astigmatism for the second light flux and
the objective lens is arranged in the optical pickup such that the astigmatism for the second light flux of the objective lens has a minimum value when an image height along a tracking direction of the objective lens is in a range of 0.3Y-0.95Y.

35. The objective lens of claim 34,
wherein the astigmatism providing structure is arranged such that the astigmatism providing structure provides predefined astigmatism amounts for a light flux with the first light flux and the second light flux respectively to the objective lens.

36. The objective lens of claim 35,
wherein the astigmatism providing structure is a diffractive structure.

37. The objective lens of claim 36,
wherein the diffractive structure is a diffractive structure having linear structures.

38. The objective lens of claim 21,
wherein the spherical aberration correcting structure is a diffractive structure.

39. The objective lens of claim 38,
wherein the diffractive structure comprises diffractive ring-shaped zones and has a serrated sectional form.

40. The objective lens of claim 21,
wherein the objective lens is arranged in the optical pickup apparatus such that the astigmatism of the objective lens has a direction to reduce astigmatism caused by the first light flux because of a tracking operation and an astigmatism caused by an astigmatism difference of the first light source.

41. An optical information recording and/or reproducing apparatus, comprising the optical pickup apparatus of claim 1 and conducting at least one of recording information on the optical information media and reproducing information from the optical information media.
